(19) United States
(12) Patent Application Publication
(10) Pub. No.: US 2009/0103289 A1
(43) Pub. Date: Apr. 23, 2009

(54) Portable lamp with light-emitting diodes

(75) Inventors: Paul Petzl, Barraux (FR); Stephane Huguenin, Grenoble (FR); Nicolas Flores, Echirolles (FR)

Correspondence Address: OLIFF & BERRIDGE, PLC, P.O. BOX 320850, ALEXANDRIA, VA, 22320-4850, US

(73) Assignee: ZEDEL, Crolles (FR)

(21) Appl. No.: 12/230,668

(22) Filed: Sep. 3, 2008

(30) Foreign Application Priority Data
Oct. 23, 2007 (FR) 07/07434

(51) Int. Cl. F21L 4/00

(52) U.S. Cl. 362/157

(57) ABSTRACT

A portable lamp comprising an electric power supply module and a lighting module arranged in a triangular architecture. The lighting module comprises a printed circuit on one surface of which at least one LED and a switch are fitted. The top surface of the switch comprises a pushbutton placed against a first surface of the printed circuit. The printed circuit comprises a through hole leaving the pushbutton accessible via a second surface of the printed circuit.

### BACKGROUND OF THE INVENTION

The invention relates to a portable lamp comprising a case housing an electric power source and a lighting module equipped with a printed circuit, at least one light-emitting diode and a switch provided with an actuating pushbutton being arranged on a first surface of this circuit.

### STATE OF THE ART

Portable lamps have to comply with compactness criteria, a switch used to achieve such lamps is relatively bulky. The position of the switch has a direct influence on the global volume of the lamp. To limit the global volume of the lamp as far as possible, the lamp presents a triangular architecture. A triangular architecture is composed of three walls, a first wall acting as support for an electric power supply, a second wall on which a button for lighting the lamp corresponding to the switch is located, and a third wall comprising an optic system which can be composed of a lens. The global volume of the lamp depends on the depth of the lighting module comprising the switch, a printed circuit and at least one LED. For a lamp with a triangular architecture, the switch must be placed as far to the rear as possible, near the electric power source and as close as possible to the second wall.

Different embodiments of the lighting module are known from the prior art. A perpendicular mode, as represented in FIG. 1, imposes movement of the switch towards the front of the lamp as represented in FIG. 2, this being due to integration of the printed circuit 5. The portable lamp obtained therefore has a large depth. This architecture is not optimal from the point of view of its overall dimensions. Another embodiment of the lighting module consists in mounting the switch flat on printed circuit 5. As illustrated in FIG. 3, the printed circuit is placed under the switch enabling the depth of the lamp to be optimized. However, such an assembly implies constraints on the location of the LEDs. The constraints concerning the location of the LEDs can be seen in FIGS. 4, 5 and 6—they are too high in FIG. 6, too low in FIG. 5 or too far forwards in FIG. 4. This architecture is therefore not satisfactory for good integration of the LEDs with the optic system of the lamp.

The document US2006/0203477 describes a torchlight comprising a hollow elongate cylindrical body provided at one end thereof with a lighting module comprising a plurality of LEDs. An integrated circuit on which a pushbutton is connected is housed inside the cylindrical body. This type of torchlight is bulky and cannot easily be used as a headlamp as portable lamps with triangular architecture can be. Due to the nature of the elongate cylindrical body, integration problems due to the location of the pushbutton do not exist.

### OBJECT OF THE INVENTION

The object of the invention is to overcome the drawbacks of known devices, in particular as far as a portable lamp is concerned to limit the depth of the latter and to enable compact assembly of the lamp while keeping a flexibility for location of the LEDs.

This object is achieved by the fact that the printed circuit comprises a through hole and that the switch is arranged against said first surface of the printed circuit after the pushbutton has passed through said hole. Association of the switch and of the printed circuit thereby enables the location of the LEDs to be optimized when the lighting module is fitted in the case of the lamp and enables the size of the case to be reduced.

According to a preferred embodiment, the pushbutton and the hole of the integrated circuit are coaxial, the lighting module is integrated in a triangular lamp architecture with three walls enabling a lamp of minimal overall volume to be obtained while at the same time using conventional components such as switches comprising strips folded to form brackets on a lateral surface of said switch.

### BRIEF DESCRIPTION OF THE DRAWINGS

Other advantages and features will become more clearly apparent from the following description of particular embodiments of the invention given for non-restrictive example purposes only and represented in the accompanying drawings, in which:

FIG. 1 illustrates a printed circuit with pushbutton fitted perpendicularly according to the prior art.

FIG. 2 illustrates the positioning of the lighting module fitted perpendicularly in a case according to the prior art.

FIG. 3 illustrates a printed circuit with pushbutton fitted flat according to the prior art.

FIGS. 4, 5, 6 illustrate the possibilities of arrangement of the lighting module fitted flat in a case according to the prior art.

FIG. 7 illustrates a printed circuit with a pushbutton fitted on a first surface of the printed circuit, seen from this first surface.

FIG. 8 illustrates a printed circuit with a pushbutton fitted on a first surface of the printed circuit, seen from a second surface of the printed circuit.

FIG. 9 illustrates a lighting module according to the invention.

FIG. 10 illustrates a portable lighting lamp according to the invention.

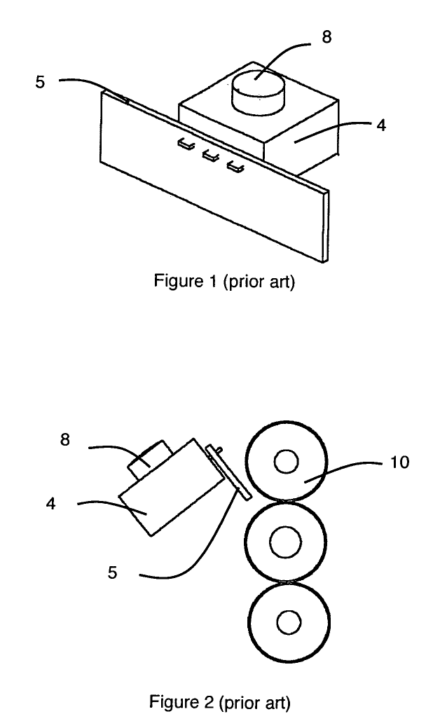

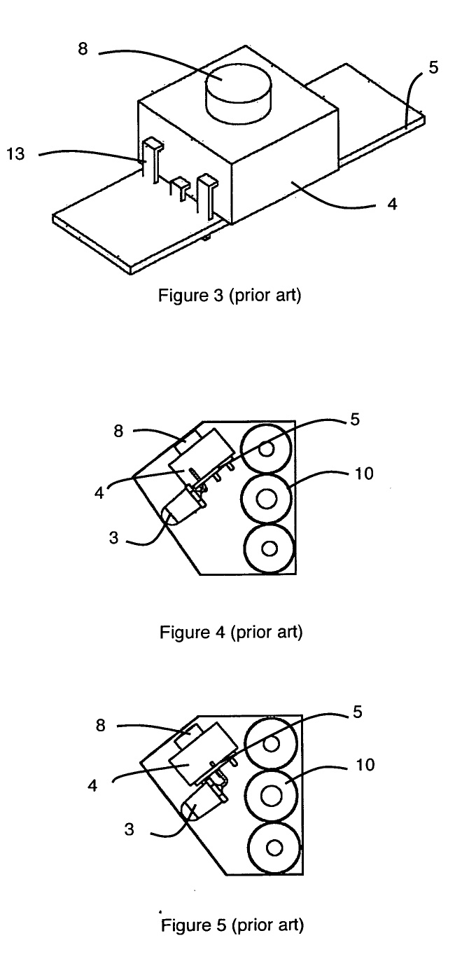

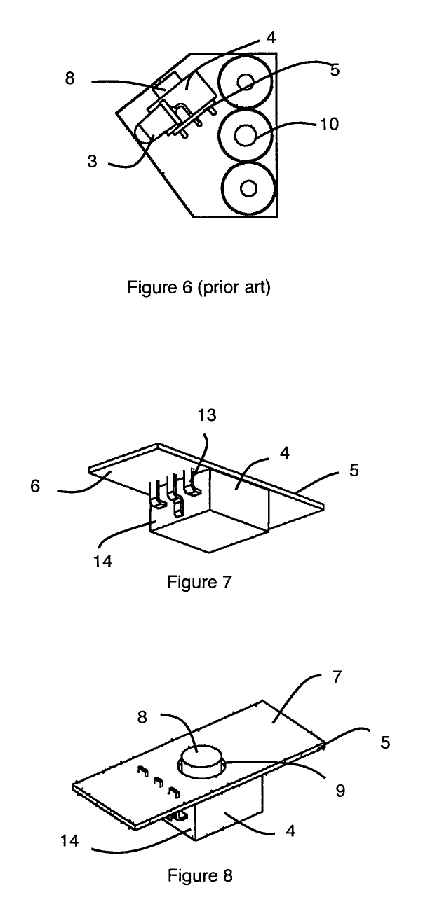

### DESCRIPTION OF THE PREFERRED EMBODIMENTS OF THE INVENTION

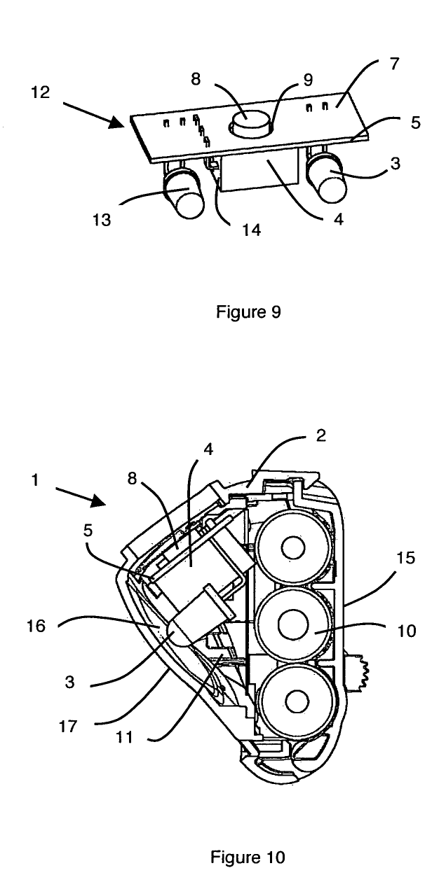

With reference to FIGS. 9 and 10, a portable lamp comprises a case 1 made of molded plastic material housing a lighting module 12 and an electric power source 10. Lighting module 12 comprises a printed circuit 5 on which a through hole 9 is made. According to FIGS. 7 and 8, the switch 4 and LED 3 components are fitted on a first surface 6 of the printed circuit 5 and can be soldered onto a second face 7 of said printed circuit 5. Switch 4 has a top surface and side surfaces, an actuating pushbutton 8 being located on the top surface and connecting strips 13 being located on one of the side faces 14. The top surface of switch 4 is facing first surface 6 of printed circuit 5. Pushbutton 8 and hole 9 of printed circuit 5 can be coaxial enabling pushbutton 8 to be accessed via hole 9 of printed circuit 5 or to let said pushbutton 8 pass through hole 9.

A lighting module 12 as defined above can be integrated in a lamp with a triangular architecture illustrated in FIG. 10. In this case, power source 10 formed for example by disposable or rechargeable batteries is placed against a first wall 15 of case 1, second surface 7 of printed circuit 5 is placed against a second top wall 2 of case 1 leaving pushbutton 8 accessible from the outside of case 1. This leaves all the available space to arrange LEDs 3, without any internal stress on case 1, in a cavity 11 of case 1, facing an optic system 16 which can be formed for example by a single lens, a Fresnel lens, a simple protective glass or no protection. Optic system 16 is placed on a third wall 17 of case 1. Cavity 11 is defined by the space left in case 1 by achievement of the triangular architecture.

Another advantage of this embodiment is that standard switches 4, comprising connecting strips 13 on a side surface 14, can be used. Strips 13 of switch 4 are folded to form brackets when the lighting module is manufactured so as to be able to fit said switch 4 on first surface 6 of printed circuit 5.

Switch 4 can comprise three positions—off, strong lighting, and weak lighting, enabling the lighting to be adjusted according to the outside conditions.

1. A portable lamp comprising a case housing an electric power source and a lighting module equipped with a printed circuit, at least one light-emitting diode and a switch provided with an actuating pushbutton being arranged on a first surface of this circuit, wherein the printed circuit comprises a through hole and the switch is arranged against said first surface of the printed circuit after the pushbutton has passed through said hole.

2. The portable lamp according to claim 1, wherein the pushbutton and said hole are coaxial.

3. The portable lamp according to claim 1, wherein the switch comprises strips folded to form brackets on a side surface of the switch.

4. The portable lamp according to claim 1, provided with an optic system, wherein the case comprises a first wall acting as support for the electric power supply, a second wall extending parallel to the printed circuit on the pushbutton side and a third wall for housing the optic system.
